(19) United States
(12) Patent Application Publication
(10) Pub. No.: US 2009/0235589 A1
(43) Pub. Date: Sep. 24, 2009

(54) BREAKAWAY ELEMENTS FOR A HORIZONTAL SIDE-MOVING DOOR

(76) Inventors: Daniel Davis, Winona, MN (US); Bill Hoerner, Dubuque, IA (US); Dean Shanahan, Dubuque, IA (US); Ryan P. Beggs, Dubuque, IA (US); Glenn R. Manich, Mequon, WI (US); James C. Boerger, Franksville, WI (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/054,138

(22) Filed: Mar. 24, 2008

(51) Int. Cl. E05D 15/48; E05D 15/52

(52) U.S. Cl. 49/192; 49/149

(57) ABSTRACT

A horizontal side-moving door with a side-winding curtain or horizontally translating panel includes a breakaway brace that helps hold a relatively rigid leading edge of the curtain or panel in a substantially vertical orientation. Should a forklift accidentally strike the leading edge of the curtain or panel, a replaceable shear pin incorporated in the brace breaks away to release the leading edge, thus protecting the edge from damage. Although the shear pin can break into two or more pieces, the brace includes means for holding the pieces in place and preventing them from falling and hitting anything underneath the pin. Although with some limitations, the door is still operational even while the pin is broken.

### FIELD OF THE DISCLOSURE

The subject disclosure relates generally to a horizontal side-moving door and more specifically to a breakaway element for such a door.

### BACKGROUND

Typical horizontal side-moving doors include either a rigid or semi-rigid planar door panel that translates horizontally in front of a doorway or a flexible door panel that coils about a roller as a leading edge of the flexible panel translates horizontally in front of the doorway. Horizontal side-moving doors with a flexible panel and a roller can be referred to as horizontal side-rolling doors.

Horizontal side-rolling doors, such as the one disclosed in U.S. Pat. No. 4,096,902; include one or two vertical rollers at either one or both lateral edges of the doorway. Some horizontal side-rolling doors have a single roller at one side of the doorway with a single curtain that extends and retracts across the full width of the doorway.

In some cases, the “single curtain” is actually comprised of two layers, each having its own vertical take-up roller. In such cases, the two rollers are right next to each other at one lateral edge of the doorway. As the door opens, the two layers of the curtain separate at the edge of the doorway and wrap upon their respective rollers.

Other horizontal side-rolling doors include two individual curtains, each supported by its own roller at opposite lateral edges of the doorway. For such doors, the leading edges of the two separate curtains meet at the center of the doorway as the door closes. To open the door, the two curtains move apart from each other and wrap upon their own roller (or set of rollers if each curtain has two layers).

The leading edges of roll-up curtains and planar door panels are often reinforced by a relatively rigid vertically elongate member that can be susceptible to being accidentally struck by a forklift passing through the doorway. The collision can damage the door, particularly the elongate member. To prevent such damage, some horizontal side-moving doors have an adjustable telescopic, spring-return arm mechanism with an internal detent or stop that helps establish a normal operating length. The arm mechanism extends diagonally between the elongate member and its supporting track follower. In the event of a collision, the arm mechanism yields resiliently to protect the door. Although somewhat effective, such a mechanism is bulky, heavy and expensive.

### BRIEF DESCRIPTION OF THE DRAWINGS

FIG. 1 is a front view a horizontal side-moving door shown in a closed position.

FIG. 2 is a front view of the door of FIG. 1 but showing the door partially open.

FIG. 3 is a front view of the door of FIG. 1 but showing the door fully open.

FIG. 4 is a cross-sectional view taken along line 4-4 of FIG. 2.

FIG. 5 is a view taken along line 5-5 of FIG. 4.

FIG. 6 is a cross-sectional view similar to FIG. 4 but showing a breakaway condition.

FIG. 7 is a cross-sectional view similar to FIG. 4 but showing another breakaway condition.

FIG. 8 is similar to FIG. 4 but showing an alternate example.

FIG. 9 is similar to FIG. 5 but showing the example of FIG. 8.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

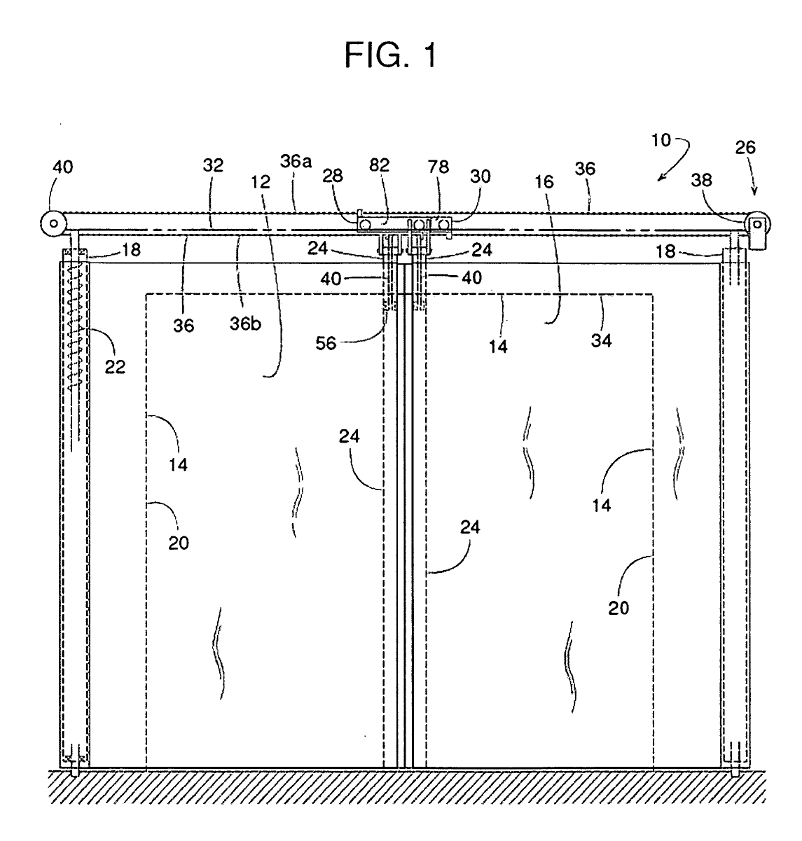

FIGS. 1-3 show a horizontal side-moving door 10 with at least one flexible curtain 12 that moves horizontally across a doorway 14 to open and close the door. In this particular example, door 10 includes two curtains 12 and 16 supported by spring-loaded rollers 18 installed in proximity with lateral edges 20 of doorway 14. A preloaded torsion spring 22 urges each roller 18 to rotate in a direction that tends to draw in and wrap the respective curtain 12 or 16 onto itself.

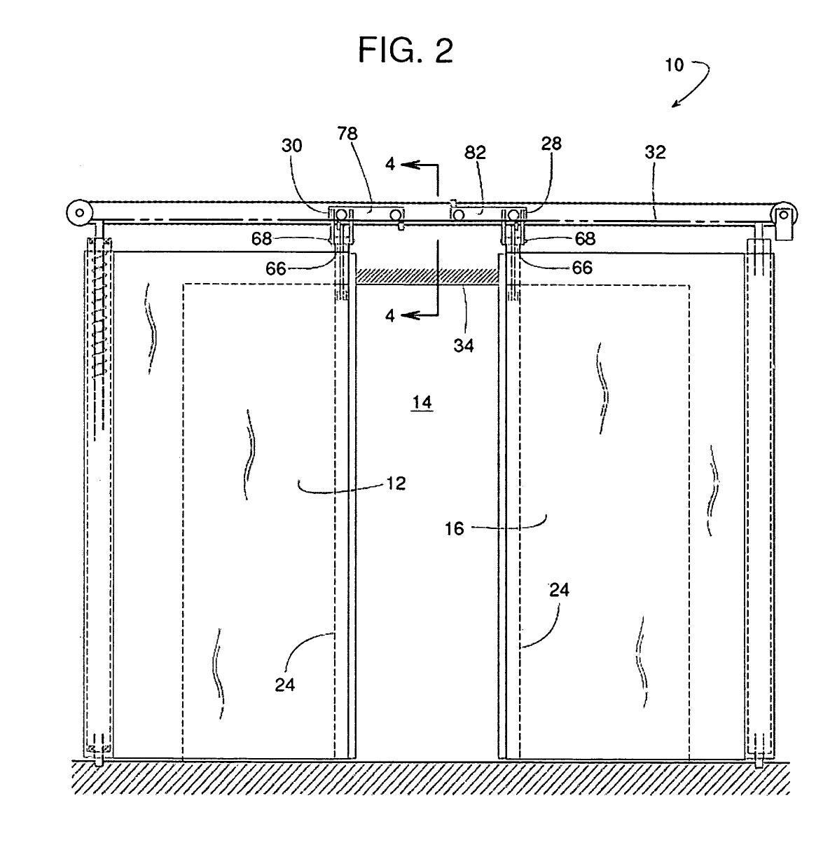

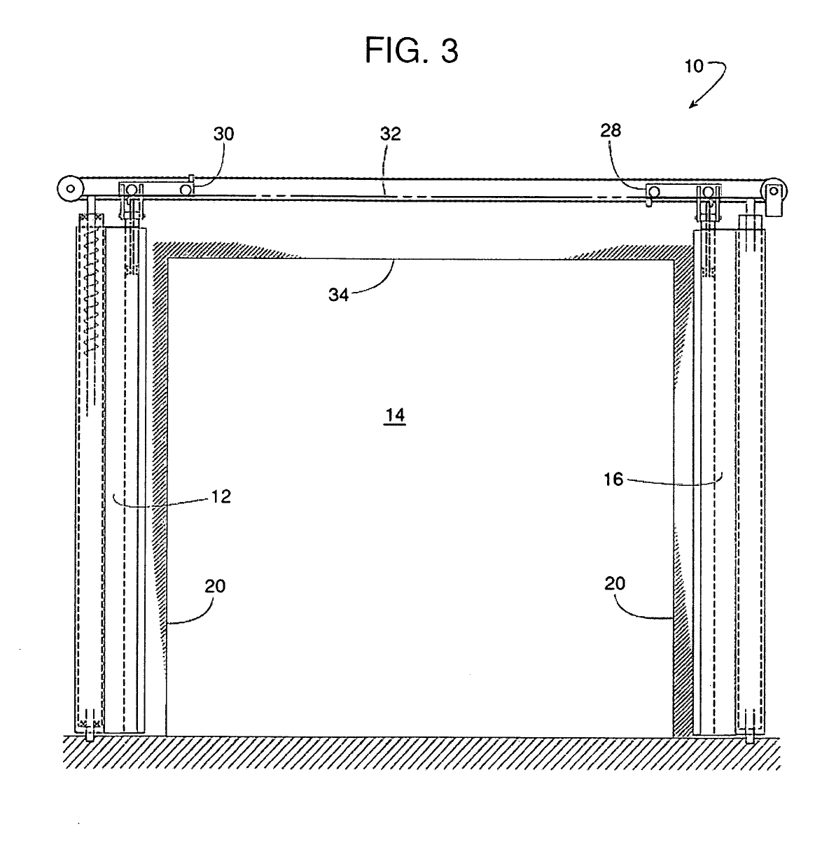

In order to open and close door 10, the leading edges of curtains 12 and 16 are attached to relatively rigid elongate members 24 that are coupled to a drive unit 26. Members 24 can be made of rectangular steel tubing or any other suitable material and having any suitable shape. For the illustrated example, drive unit 26 comprises two track followers 28 and 30 that are mounted for horizontal translation along an overhead track 32 that is installed in proximity with an upper edge 34 of doorway 14. Elongate member 24 extends downward from track follower 30, and the other elongate member 24 extends downward from track follower 28. A chain 36 and/or cogged belt powered by a motor-driven wheel 38 and an idler wheel 40 is coupled to track followers 28 and 30. Track follower 28 connects to an upper section 36a of chain 36, and track follower 30 connects to a lower section 36b of chain 36 so that depending on the rotational direction of driven wheel 38, drive unit 26 either moves elongate members 24 apart or together to respectively open or close the door 10. FIG. 1 shows door 10 closed with the curtains' leading edges abutting each other near the center of doorway 14, FIG. 3 shows door 10 open with most of the curtains wrapped around rollers 18, and FIG. 2 shows door 10 partially open. Numerous other ways of driving elongate members 24 apart and together are well within the scope of the disclosure.

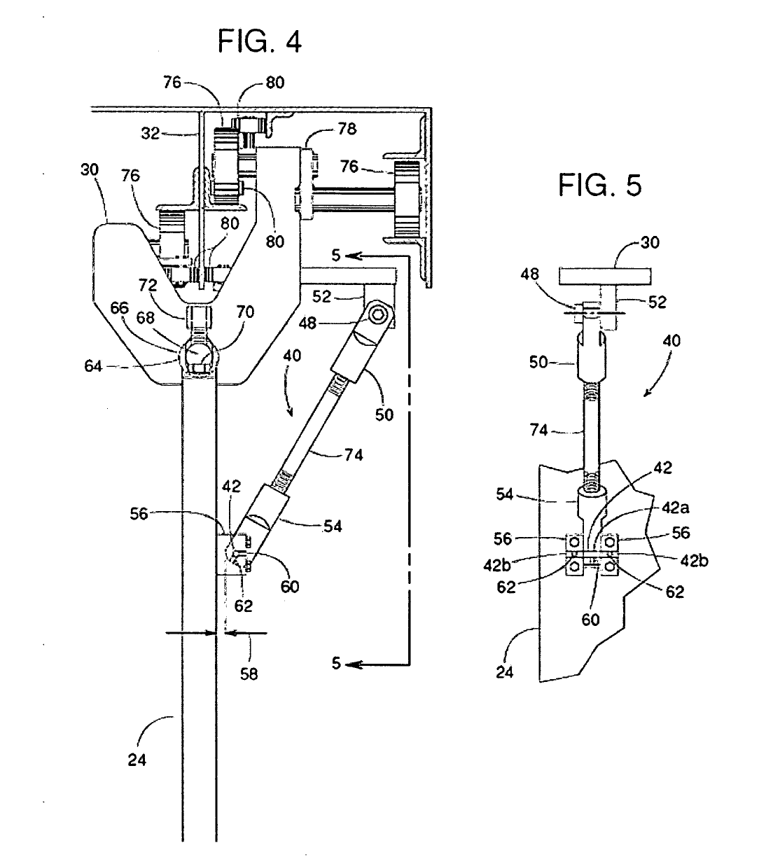

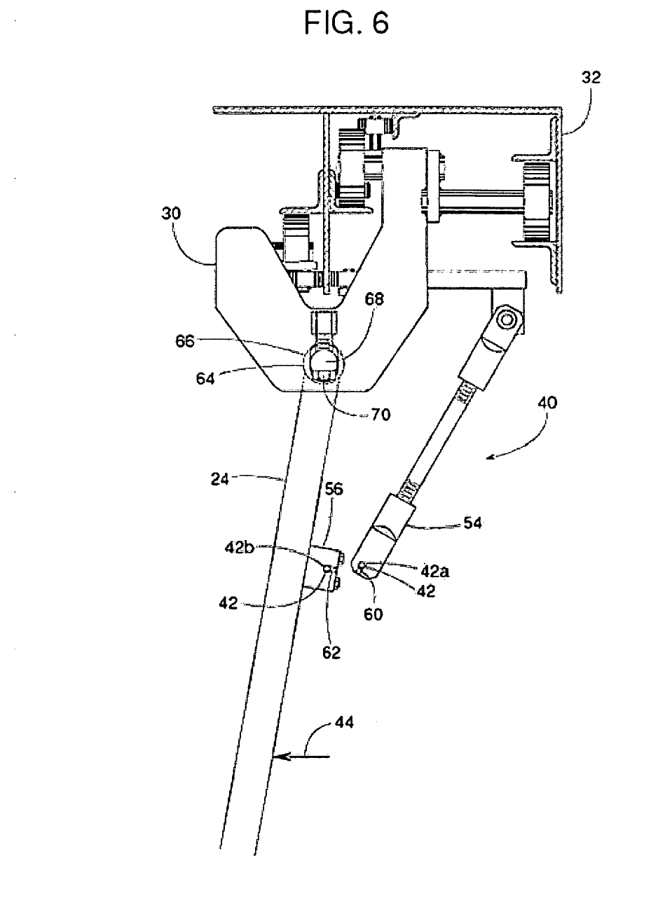

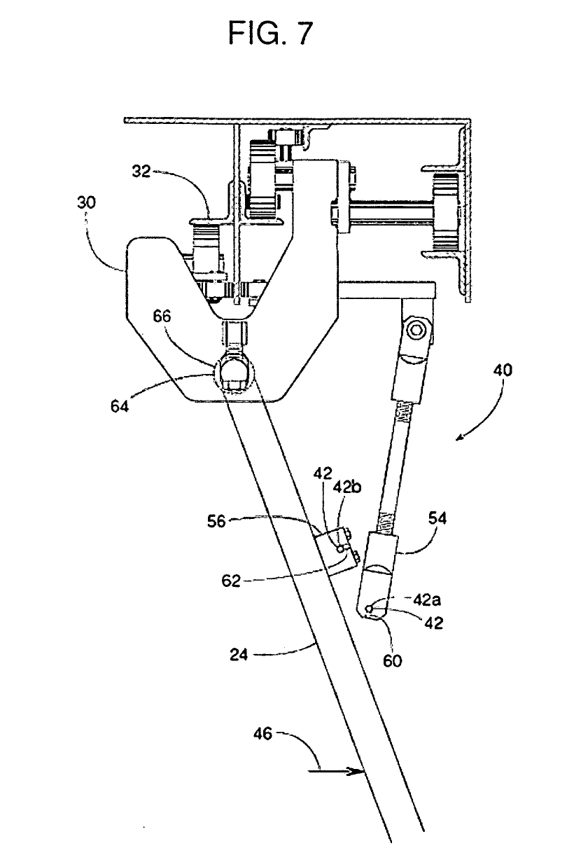

To hold elongate members 24 substantially vertical to facilitate operation and proper-closed alignment of members 24 yet still make the door 10 able to survive an accidental impact with a forklift or some other collision, elongate members 24 are each supported by a brace 40 that includes a readily replaceable, inexpensive breakable member 42, as shown in FIGS. 4-7. FIGS. 4 and 5 show brace 40 in a usual configuration with elongate member 24 being in a vertical operative position. FIG. 6 shows a force of impact 44 forcing elongate member 24 to one dislodged position, and FIG. 7 shows another impact force 46 in an opposite direction forcing member 24 to another dislodged position.

In the operative position of FIGS. 4 and 5, a conventional fastener 48 pivotally connects an upper end 50 of brace 40 to a lug 52 on track follower 30, and breakable member 42 connects a lower end 54 of brace 40 to two lugs 56 extending from elongate member 24. In this example, breakable member 42 is in the form of a steel shear pin extending through end 54 and lugs 56; however, breakable member 42 could be of various other designs and could be installed as any breakable link between track follower 30 and elongate member 24. The location of breakable member 42 and fastener 48, for instance, could be interchanged.

If force 44 or 46 is excessive, breakable member 42 shears or breaks from being in an intact shape (FIG. 5) into multiple pieces (FIG. 6 or 7), thereby protectively releasing elongate member 24 from brace 40. Sufficient clearance 58 (FIG. 4) between lower end 54 and elongate member 24 preferably exists to prevent an otherwise lack of clearance from resisting the breakaway movement of brace 40 relative to elongate member 24, particularly when the breakaway action is as shown in FIG. 7.

Upon breakage, to prevent any broken pieces of member 42 from falling to the floor or striking someone or something, a setscrew 60 screwed into lower end 54 and holds a central section 42a (first piece) of breakable member 42 to end 54, and other setscrews 62 screwed into lugs 56 hold broken end pieces (second piece) 42b to lugs 56.

After a breakaway incident, setscrews 60 and 62 can be partially unscrewed, and the broken pieces of member 42 can be replaced by an unbroken member 42 of intact shape. Until such a repair can be done, a pivotal coupling 64 between elongate member 24 and track follower 30 allows member 24 to hang generally vertical so that door 10 can still be open and closed while brace 40 is disconnected.

Pivotal coupling 64 can be a sleeve 66 journalled to a generally horizontal shaft 68, wherein shaft 68 is attached to track follower 30, and sleeve 66 is attached to the upper end of elongate member 24. Such a coupling permits pivotal motion in the same general direction that forklifts pass through doorway 14, thus elongate member 24 can “break away” or swing in a direction that member 24 is mostly likely to be struck.

To ensure that the leading edges of curtains 12 and 16 can come together in sealingly tight engagement when door 10 closes, elongate members 24 preferably hang generally parallel and vertical as viewed face-on in FIG. 1. To accomplish this, an adjustment screw 70 between one end of shaft 68 and a lug 72 extending from track follower 30 can be tightened or loosened to level shaft 68.

To ensure that the leading edges of curtains 12 and 16 are substantially coplanar, the length of brace 40 can be made adjustable. In a preferred example, a threaded shank 74 of brace 40 can be screwed farther in or out of ends 50 and/or 54 to adjust the brace's 40 overall length.

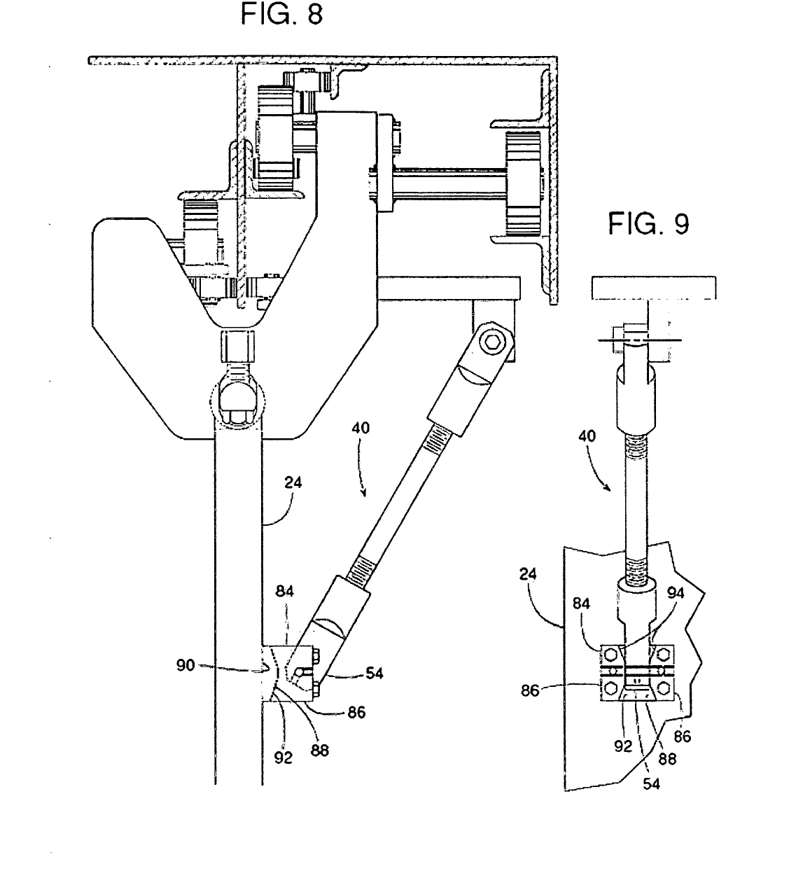

In an alternate example, shown in FIGS. 8 and 9, a shear pin block 84 replaces lugs 56. Shear pin block 84 includes certain beveled surfaces to avoid binding between block 84 and lower end 54 as member 42 breaks away. In some cases, shear block 84 comprises two lugs 86 extending from a base 88 attached to a mounting surface 90 of elongate member 24. At breakaway, to avoid binding between base 88 and lower end 54, base 88 includes a beveled surface 92 that generally faces brace 40, as shown in FIG. 8. Surface 92 is angularly displaced out of coplanar alignment with mounting surface 90 to create a ramp along which lower end 54 could readily slide rather than bind. Binding can be further avoided by having lugs 86 include two beveled surfaces 94 that are displaced out of coplanar alignment with each other, as shown in FIG. 9.

It should be noted that the actual structure of track 32 and track followers 28 and 30 could vary widely and still be within the scope of the disclosure. In the illustrated example, track follower 30 includes several rollers 76 for weight support and for limiting the tipping of track follower 30. An extension arm 78 can enhance the track follower's 30 ability to resist tipping. Additional rollers 80 can further resist tipping and help guide the track follower 30 along the length of track 32. In some cases, extension arm 78 on track follower 30 and a similar extension arm 82 on track follower 28 can pass by each other in an overlapping relationship, as shown in FIG. 1. Although chain 36 is shown coupled to extension arms 78 and 82, this was illustrated in this manner to clearly show the functional relationship between chain 36 and track followers 28 and 30. Chain 36 can be connected to any other suitable point(s) on track followers 28 and 30.

At least some of the aforementioned examples include one or more features and/or benefits including, but not limited to, the following:

In some examples, a horizontal side-moving door includes a breakaway feature that protects the door from permanent damage in the event of a collision with the door.

In some examples, the breakaway feature is incorporated in a brace that is used for holding a leading edge of the door's curtain substantially vertical.

In some examples, the horizontal side-moving door is still functional even after a breakaway incident occurs.

In some examples, the breakaway feature includes a shear pin that does not fall to the floor after it shears into multiple pieces.

In some examples, a breakable member is incorporated in a brace that is used for holding a leading edge of the door's curtain substantially vertical. Other than the breakable member breaking, the brace basically has no moving parts once the brace is installed.

In some examples, after the breakable member breaks, a pivotal connection between a track follower and a reinforced leading edge of the door's curtain allows the relatively rigid leading edge to swing away from the general direction of impact.

The foregoing examples provide a better way of protecting a horizontal side moving door from impact. Furthermore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed:

1. A door for a wall defining a doorway with an upper edge and a lateral edge, the door comprising:
a track mountable in proximity with the upper edge of the doorway;
a track follower mounted for horizontal translation along the track;
an elongate member extending downward from the track follower, the elongate member is forcibly movable from an operative position to a dislodged position, wherein the elongate member is generally vertical in the operative position and is at an appreciable incline in the dislodged position;
a brace extending from the track follower to the elongate member to help hold the elongate member generally vertical in the operative position; and
a breakable member coupling the brace to at least one of the elongate member and the track follower, wherein the breakable member breaks from an intact shape into at least a first piece and a second piece in reaction to the elongate member being forcibly moved from the operative position to the dislodged position by a force above a predetermined magnitude.

2. The door of claim 1, further comprising:
a roller extending vertically and being mountable in proximity with the lateral edge of the doorway; and
a curtain wrapped around the roller such that the roller upon rotating selectively takes in and pays out the curtain substantially horizontally to respectively open and close the door, the curtain includes a leading edge attached to the elongate member.

3. The door of claim 1, wherein the first piece of the breakable member remains with the brace when the elongate member moves from the operative position to the dislodged position.

4. The door of claim 1, further comprising a screw engaging the breakable member such that the screw holds at least one of the first piece and the second piece to the door when the elongate member is at the dislodged position.

5. The door of claim 1, wherein the breakable member is a pin.

6. The door of claim 1, wherein the brace has an adjustable length.

7. The door of claim 1, wherein the door can still open and close after the breakable member breaks into the first piece and the second piece.

8. The door of claim 1, wherein the breakable member connects the brace to the elongate member.

9. The door of claim 1, wherein the elongate member is pivotal about a substantially horizontal axis after the breakable member breaks into the first piece and the second piece.

10. The door of claim 1, wherein the elongate member is more rigid than the curtain.

11. The door of claim 1, further comprising a shear pin block that includes a lug and a base, the base is attached to a mounting surface of the elongate member, the lug is connected to the breakable member, the base includes a beveled surface generally facing the brace, wherein the beveled surface is angularly displaced out of coplanar alignment with the mounting surface of the elongate member.

12. The door of claim 1, further comprising a shear pin block attached to the elongate member, the breakable member connects the brace to the shear pin block, the shear pin block includes two beveled surfaces between which the brace extends, wherein the two beveled surfaces are displaced out of coplanar alignment with each other.

13. A door for a wall defining a doorway with an upper edge and a lateral edge, the door comprising:
a track mountable in proximity with the upper edge of the doorway;
a track follower mounted for horizontal translation along the track;
an elongate member extending downward from the track follower, the elongate member is forcibly pivotal relative to the track follower about a substantially horizontal axis from an operative position to a dislodged position, wherein the elongate member is generally vertical in the operative position and is at an appreciable incline in the dislodged position;
a brace having an adjustable length and extending from the track follower to the elongate member to help hold the elongate member generally vertical in the operative position;
a breakable member coupling the brace to at least one of the elongate member and the track follower, wherein:
the breakable member breaks from an intact shape into at least a first piece and a second piece in reaction to the elongate member being forcibly moved from the operative position to the dislodged position by a force above a predetermined magnitude,
the first piece of the breakable member remains with the brace when the elongate member moves from the operative position to the dislodged position, and
the door can still open and close after the breakable member breaks into the first piece and the second piece,
a roller extending vertically and being mountable in proximity with the lateral edge of the doorway; and
a curtain wrapped around the roller such that the roller upon rotating selectively takes in and pays out the curtain substantially horizontally to respectively open and close the door, the curtain includes a leading edge attached to the elongate member, wherein the elongate member is more rigid than the curtain.

14. The door of claim 13, further comprising a screw engaging the breakable member such that the screw holds at least one of the first piece and the second piece to the door when the elongate member is at the dislodged position.

15. The door of claim 13, wherein the breakable member is a pin.

16. The door of claim 13, wherein the breakable member connects the brace to the elongate member.

17. The door of claim 13, further comprising a shear pin block that includes a lug and a base, the base is attached to a mounting surface of the elongate member, the lug is connected to the breakable member, the base includes a beveled surface generally facing the brace, wherein the beveled surface is angularly displaced out of coplanar alignment with the mounting surface of the elongate member.

18. The door of claim 13, further comprising a shear pin block attached to the elongate member, the breakable member connects the brace to the shear pin block, the shear pin block includes two beveled surfaces between which the brace extends, wherein the two beveled surfaces are displaced out of coplanar alignment with each other.
